(19) United States
(12) Patent Application Publication
(10) Pub. No.: US 2019/0221171 A1
(43) Pub. Date: Jul. 18, 2019

(54) PARTITIONED BACKLIGHT DISPLAY METHOD OF RED, GREEN, BLUE, AND WHITE (RGBW) DISPLAY DEVICE

(71) Applicant: WUHAN CHINA STAR OPTOELECTRONICS TECHNOLOGY CO., LTD., Wuhan, Hubei (CN)

(72) Inventor: Guowei Zha, Wuhan, Hubei (CN)

(21) Appl. No.: 15/574,360

(22) PCT Filed: Sep. 11, 2017
(86) PCT No.: PCT/CN2017/101159

§ 371 Date: Nov. 15, 2017

(30) Foreign Application Priority Data
Jul. 14, 2017 (CN) 201710576251.8

(51) Int. Cl. G09G 3/34; G09G 3/36

(52) U.S. Cl. CPC G09G 3/3426; G09G 3/3413; G09G 3/3607; G09G 2360/16; G09G 2320/0686; G09G 2320/0626; G09G 2320/0242

(57) ABSTRACT

The present invention provides a partitioned backlight display method and device of a red, green, blue, and white (RGBW) display. Converting the RGB display to the RGBW avoids problems of pure color darkness from different pixel gain inconsistencies, independently sets saturation gain value in different partitions based on specific screens, and maximizes and enhances penetration rate of W sub-pixel brightness gain effect.

### BACKGROUND OF THE INVENTION

### Field of Invention

The present invention relates to displays, and particularly to a partitioned backlight display method of a red, green, blue, and white (RGBW) display device.

### Description of Prior Art

Key display technology can reproduce the human eye for visual perception of nature. Current mainstream display technology includes liquid crystal display (LCD) display technology and organic light-emitting diode (OLED) display technology. The LCD display technology has clear cost and reliability advantages. And the OLED technology, as a late start display technology, still has higher costs, limited life, and other issues.

But with progress of technology and supply chain improvement, the OLED display technology has gradually narrowed the distance with the LCD display technology, and at the same time, the OLED display technology shows high color gamut advantages and high contrast advantages etc.

Dynamic partitioning backlight allows backlighting of different partitions to independently adjust brightness of partition backlights based on contents of the current display. But the adjustment of the backlight is still limited in a large range of a single partition, the pixels within any partition still share a same brightness of the backlight, it is difficult to match a self-luminous adjustment effect of a single sub-pixel of the OLED.

Four-color display technology (such as RGBW) is made by adding a white W pixels to a traditional red, green, and blue (RGB) hue arrangement, since the white pixel W usually uses a high transmittance OC flat layer instead of a low transmittance colorant layer, the RGB pixel arrangement has high brightness and low power advantages. At present, a brightness of a liquid crystal displaying module with the traditional RGB pixel arrangement is 400-500 nits, and the maximum transmittance of the W sub-pixel is about 100-150% more than that of the RGB pixel, so that the maximum brightness can be about 700-1200 nits. And, the W sub-pixel as a single sub-pixel can adjust the brightness of a single pixel at the pixel level, and has a function similar to “dynamic backlight” to make the LCD have a dynamic backlight adjustment level similar to the OLED.

It is also difficult to use a appropriate algorithm to combine a partitioned backlight and a RGBW display technology.

Therefore, the conventional technology has yet to be improved and developed.

### SUMMARY OF THE INVENTION

The application mainly provides a partitioned backlight display method of a RGBW display device, thereby realizing a partitioned backlight display function of the RGBW.

For the above-mentioned objective, the present disclosure employs the following technical schemes.

A partitioned backlight display method of a RGBW display device comprises:

dividing a red, green, and blue (RGB) image into a plurality of image partitions based on a backlight partition setting information, each image partition comprising a plurality of RGB pixels;

obtaining a gray scale value of each RGB pixel and converting the gray scale value to a hue, saturation, and value (HSV) space to obtain a saturation of the RGB pixel;

determining each of the of RGB pixels being a high-purity color RGB pixel or a non-high-purity color RGB pixel based on the saturation and generating a determining result;

obtaining a saturation gain corresponding to each of the RGB pixels when each RGB pixel is pre-converted into a RGBW pixel;

obtaining a corrected target saturation gain by correcting the saturation gain of each RGB pixel based on the determining result and a visual luminance gain coefficient of each RGB pixel;

setting a saturation gain threshold corresponding to each image partition, and performing an optimization process on the target saturation gain for each RGB pixel in the image partition based on the saturation gain threshold;

obtaining a gray scale value of the RGBW pixel by converting the RGB pixel into an RGBW pixel according to the target saturation gain after the optimization process;

obtaining a target backlight luminance gain coefficient based on the gray scale value of each RGBW pixel in the image partition and the saturation gain threshold corresponding to the image partition;

obtaining a gray scale compensation screen of the image partition based on the target backlight luminance gain coefficient of the image partition and the gray scale value of the RGBW pixel in the image partition; and

displaying based on the gray scale compensation screen of each the image partition.

In one exemplary embodiment, in the partitioned backlight display method of the RGBW display device, the step of obtaining a target backlight luminance gain coefficient based on the gray scale value of each RGBW pixel in the image partition and the saturation gain threshold corresponding to the image partition comprises:

setting the backlight luminance gain coefficient in the image partition based on the gray scale value of the RGBW pixel in the image partition; and

obtaining the target backlight luminance gain coefficient by correcting the backlight luminance gain coefficient in the image partition based on the saturation gain threshold.

In one exemplary embodiment, in the partitioned backlight display method of the RGBW display device, the step of performing an optimization process on the target saturation gain for each RGB pixel in the image partition based on the saturation gain threshold comprises:

adjusting the target saturation gain of the RGB pixel to the corresponding saturation gain threshold when the target saturation gain of the RGB pixel of the image partition is more than the corresponding saturation gain threshold.

In one exemplary embodiment, in the partitioned backlight display method of the RGBW display device, the step of obtaining a corrected target saturation gain by correcting the saturation gain of each RGB pixel based on the determining result and a visual luminance gain coefficient of each RGB pixel comprises:

obtaining a visual luminance gain coefficient x of each RGB pixel;

the target saturation gain of the RGB pixel has n=mx, when the RGB pixel is a high-purity color RGB pixel;

the target saturation gain n=m, when the RGB pixel is a high purity color RGB pixel; and

wherein, m is the saturation gain of the RGB pixel.

In one exemplary embodiment, in the partitioned backlight display method of the RGBW display device, the step of obtaining a gray scale value of each RGB pixel and converting the gray scale value to a HSV space to obtain a saturation of the RGB pixel comprises:

normalizing the RGB pixels and obtaining a gray scale values of the normalized RGB pixels; and

obtaining the saturation of the RGB pixel by converting the gray scale value of the RGB pixel to the HSV space.

A partitioned backlight display device for RGBW displaying comprises:

a dividing module for dividing a RGB image into a plurality of image partitions based on a backlight partition setting information, each image partition comprising a plurality of RGB pixels;

a first obtaining module for obtaining a gray scale value of each RGB pixel and converting the gray scale value to a hue, saturation, and value (HSV) space to obtain a saturation of the RGB pixel;

a determining module for determining each of the of RGB pixels being a high-purity color RGB pixel or a non-high-purity color RGB pixel based on the saturation and generating a determining result;

a second obtaining module for obtaining a saturation gain corresponding to each of the RGB pixels when each RGB pixel is pre-converted into a RGBW pixel;

a correcting module for obtaining a corrected target saturation gain by correcting the saturation gain of each RGB pixel based on the determining result and a visual luminance gain coefficient of each RGB pixel;

an optimization module for setting a saturation gain threshold corresponding to each image partition, and performing an optimization process on the target saturation gain for each RGB pixel in the image partition based on the saturation gain threshold;

a third obtaining module for obtaining a gray scale value of the RGBW pixel by converting the RGB pixel into an RGBW pixel according to the target saturation gain after the optimization process;

a fourth obtaining module for obtaining a target backlight luminance gain coefficient based on the gray scale value of each RGBW pixel in the image partition and the saturation gain threshold corresponding to the image partition;

a fifth obtaining module for obtaining a gray scale compensation screen of the image partition based on the target backlight luminance gain coefficient of the image partition and the gray scale value of the RGBW pixel in the image partition; and

a displaying module for displaying based on the gray scale compensation screen of each the image partition.

In one exemplary embodiment, in the partitioned backlight display device for RGBW displaying, the fourth obtaining module comprises:

a setting unit for setting the backlight luminance gain coefficient in the image partition based on the gray scale value of the RGBW pixel in the image partition; and

a correcting unit for obtaining the target backlight luminance gain coefficient by correcting the backlight luminance gain coefficient in the image partition based on the saturation gain threshold.

In one exemplary embodiment, in the partitioned backlight display device for RGBW displaying, the optimization module comprises:

a first setting unit for setting a saturation gain threshold corresponding to each image partition; and

an optimization unit for adjusting the target saturation gain of the RGB pixel to the corresponding saturation gain threshold when the target saturation gain of the RGB pixel of the image partition is more than the corresponding saturation gain threshold.

In one exemplary embodiment, in the partitioned backlight display device for RGBW displaying, the correcting module comprises:

a first obtaining unit for obtaining a visual luminance gain coefficient x of each RGB pixel;

a second setting unit for setting the target saturation gain of the RGB pixel to mx, when the RGB pixel is a high-purity color RGB pixel;

a third setting unit for setting the target saturation gain to m when the RGB pixel is a high purity color RGB pixel; and

wherein, m is the saturation gain of the RGB pixel.

In one exemplary embodiment, in the partitioned backlight display device for RGBW displaying, the first obtaining module comprises:

a normalization unit for normalizing the RGB pixels and obtaining a gray scale values of the normalized RGB pixels; and

a second obtaining unit for obtaining the saturation of the RGB pixel by converting the gray scale value of the RGB pixel to the HSV space.

A partitioned backlight display device for RGBW displaying comprises:

a dividing module for dividing a RGB image into a plurality of image partitions based on a backlight partition setting information, each image partition comprising a plurality of RGB pixels;

a first obtaining module for obtaining a gray scale value of each RGB pixel and converting the gray scale value to a hue, saturation, and value (HSV) space to obtain a saturation of the RGB pixel;

a determining module for determining each of the of RGB pixels being a high-purity color RGB pixel or a non-high-purity color RGB pixel based on the saturation and generating a determining result;

a second obtaining module for obtaining a saturation gain corresponding to each of the RGB pixels when each RGB pixel is pre-converted into a RGBW pixel;

a correcting module for obtaining a corrected target saturation gain by correcting the saturation gain of each RGB pixel based on the determining result and a visual luminance gain coefficient of each RGB pixel;

an optimization module for setting a saturation gain threshold corresponding to each image partition, and performing an optimization process on the target saturation gain for each RGB pixel in the image partition based on the saturation gain threshold;

a third obtaining module for obtaining a gray scale value of the RGBW pixel by converting the RGB pixel into an RGBW pixel according to the target saturation gain after the optimization process;

a fourth obtaining module for obtaining a target backlight luminance gain coefficient based on the gray scale value of each RGBW pixel in the image partition and the saturation gain threshold corresponding to the image partition;

a fifth obtaining module for obtaining a gray scale compensation screen of the image partition based on the target backlight luminance gain coefficient of the image partition and the gray scale value of the RGBW pixel in the image partition; and

a displaying module for displaying based on the gray scale compensation screen of each the image partition;

wherein the fourth obtaining module comprising:

a setting unit for setting the backlight luminance gain coefficient in the image partition based on the gray scale value of the RGBW pixel in the image partition; and

a correcting unit for obtaining the target backlight luminance gain coefficient by correcting the backlight luminance gain coefficient in the image partition based on the saturation gain threshold;

wherein the optimization module comprising:

a first setting unit for setting a saturation gain threshold corresponding to each image partition; and

an optimization unit for adjusting the target saturation gain of the RGB pixel to the corresponding saturation gain threshold when the target saturation gain of the RGB pixel of the image partition is more than the corresponding saturation gain threshold;

wherein the correcting module comprising:

a first obtaining unit for obtaining a visual luminance gain coefficient x of each RGB pixel;

a second setting unit for setting the target saturation gain of the RGB pixel to mx, when the RGB pixel is a high-purity color RGB pixel;

a third setting unit for setting the target saturation gain to m when the RGB pixel is a high purity color RGB pixel; and

wherein, m is the saturation gain of the RGB pixel; and

wherein the first obtaining module comprising:

a normalization unit for normalizing the RGB pixels and obtaining a gray scale values of the normalized RGB pixels; and

a second obtaining unit for obtaining the saturation of the RGB pixel by converting the gray scale value of the RGB pixel to the HSV space.

From the above, in this application, converting the RGB display to the RGBW avoids problems of pure color darkness from different pixel gain inconsistencies, independently sets saturation gain value in different partitions based on specific screens, and maximizes and enhances penetration rate of W sub-pixel brightness gain effect.

### BRIEF DESCRIPTION OF THE DRAWINGS

FIG. 1 is a flowchart of a partitioned backlight display method of a RGBW display device according to one exemplary embodiment of the present disclosure.

FIG. 2 is a structure diagram of a partitioned backlight display device for RGBW displaying according to one exemplary embodiment of the present disclosure.

### DETAILED DESCRIPTION OF THE PREFERRED EMBODIMENTS

The description of following embodiment, with reference to the accompanying drawings, is used to exemplify specific embodiments which may be carried out in the present disclosure. Directional terms mentioned in the present disclosure, such as “top”, “bottom”, “front”, “back”, “left”, “right”, “inside”, “outside”, “side”, etc., are only used with reference to the orientation of the accompanying drawings. Therefore, the used directional terms are intended to illustrate, but not to limit, the present disclosure. In the drawings, the components having similar structures are denoted by same numerals

In the figures, modules with similar structures are denoted by the same reference numerals.

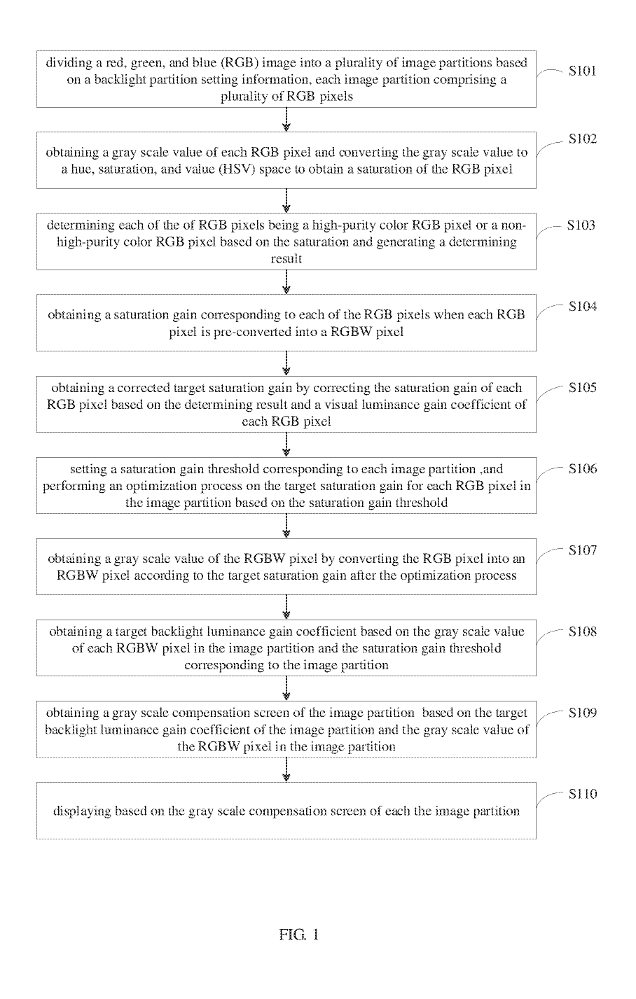

Referring to FIG. 1, FIG. 1 is a flowchart of a partitioned backlight display method of a RGBW display device according to one exemplary embodiment of the present disclosure. The method comprises:

S101, dividing a RGB image into a plurality of image partitions based on a backlight partition setting information, each image partition comprising a plurality of RGB pixels;

S102, obtaining a gray scale value of each RGB pixel and converting the gray scale value to a hue, saturation, and value (HSV) space to obtain a saturation of the RGB pixel;

S103, determining each of the of RGB pixels being a high-purity color RGB pixel or a non-high-purity color RGB pixel based on the saturation and generating a determining result;

S104, obtaining a saturation gain corresponding to each of the RGB pixels when each RGB pixel is pre-converted into a RGBW pixel;

S105, obtaining a corrected target saturation gain by correcting the saturation gain of each RGB pixel based on the determining result and a visual luminance gain coefficient of each RGB pixel;

S106, setting a saturation gain threshold corresponding to each image partition, and performing an optimization process on the target saturation gain for each RGB pixel in the image partition based on the saturation gain threshold;

S107, obtaining a gray scale value of the RGBW pixel by converting the RGB pixel into an RGBW pixel according to the target saturation gain after the optimization process;

S108, obtaining a target backlight luminance gain coefficient based on the gray scale value of each RGBW pixel in the image partition and the saturation gain threshold corresponding to the image partition;

S109, obtaining a gray scale compensation screen of the image partition based on the target backlight luminance gain coefficient of the image partition and the gray scale value of the RGBW pixel in the image partition; and

S110, displaying is base on the gray scale compensation screen of the each image partition.

Describing in detail of the various steps of the partition backlight display method base on the attached drawings.

In the step S101, each RGB pixel comprises a red sub-pixel, a green sub-pixel, and a blue sub-pixel. A backlight partitioned information is set by the display contents of the screen.

In the step S102, normalizing the respective image partitions before the step of obtaining the gray scale value of each of the RGB pixels. For example, normalizing each image partition by using the normalization of the gamma conversion rule. The step S102 comprises:

S1021, obtaining a normalized gray scale value of the RGB pixels by normalizing the RGB pixels.

S1022, obtaining the saturation of the RGB pixel by converting the gray scale value of the RGB pixel to the HSV space.

Specifically, the each RGB pixel gray scale value is marked as Pic (H, L, a) before the normalization processing, each of H and L is the abscissa and the ordinate of the sub-pixel, and a is used to identify the color of the sub-pixel, for example, when a=1, the sub-pixel is a red sub-pixel, when a=2, the sub-pixel is a green sub-pixel, and when a=3, the sub-pixel is a blue sub-pixel. When gamma=2.2, the gray scale value of the normalized sub-pixel is recorded as In (H, L, a)=Pic ((H, L, a)/255)^{2.2}.

After the normalization processing and getting the gray scale value of the normalized sub-pixel, the gray scale value of each sub-pixel is converted to the HSV space to obtain the saturation of the RGB pixel. The main screening colors are R (red), G (green), B (blue), C (cyan), M (mauve) and Y (yellow).

In the step S103, the saturation of the RGB pixel is higher than the threshold value is the high-purity color pixel, and the saturation is lower than the threshold value is the non-high-purity color pixel. Calibrating the pixels base on the above colors. The threshold value can be set with the reference image taste, and in at least one embodiment, the threshold value is set to 0.8.

In the step S104, when the RGB pixels are pre-converted to RGBW pixels to obtain the saturation gain corresponding to the sub-pixels of the respective RGB pixels, and the conversion is not performed here. The RGBW pixels include red sub-pixels, green sub-pixels, blue sub-pixels and white sub-pixels.

In the step S105, the visual luminance gain coefficients corresponding to R (red), G (green), B (blue), C (cyan), M (mauve) and Y (yellow) are set to 1.5, 1.2, 1.5, 1.35, 1.5 and 1.1. For the high-purity color pixels are timed by the visual luminance gain coefficients corresponding to R (red), G (green), B (blue), C (cyan), M (mauve) and Y (yellow), for non-high purity color pixels is timed by 1 to get the target saturation gain.

In the step S106, firstly, the target saturation gain of each RGB pixel is calculated. Then, base on the statistical situation, a saturation gain threshold gain_final of each different image partition is set, and base on the saturation threshold gain_final, the gray scale value of the RGB pixel in the image partition is optimized.

In particular, when the target saturation gain of an RGB pixel within the image partition is more than the corresponding saturation gain threshold, the target saturation gain of the RGB pixel is adjusted to the corresponding saturation gain threshold.

In the step S107, the RGB pixels is converted into an RGBW pixel according to the target saturation gain after the optimization process to obtain a gray scale value of the RGBW pixel. For one RGBW pixel, the gray scale value is recorded as (Rᵢₙ, Gᵢₙ, Bᵢₙ, Wᵢₙ).

In the step S108, the step comprises:

S1081, setting the backlight luminance gain coefficient in the image partition based on the gray scale value of the RGBW pixel in the image partition. the backlight luminance gain coefficient Blu_temp of the current partition is determined by the statistical distribution of all RGBW pixels (R, G B, W) values in the current image partition. Specifically, the maximum value or the average value of the gray scale value of the RGBW pixel of the current image partition may be referred. When the maximum value of the gray scale of all RGBW pixels in the current partition is 1, the backlight brightness gain coefficient Blu_temp=1; when the maximum value of the gray scale of all RGBW pixels in the current partition is 0, the backlight brightness gain coefficient Blu_temp=0.

S1082, obtaining the target backlight luminance gain coefficient by correcting the backlight luminance gain coefficient in the image partition based on the saturation gain threshold. The target backlight luminance gain coefficient Blu=Blu_temp/gain_final, and the backlight gain coefficient is outputted to the backlight drive unit to light up the backlight of the corresponding image partition.

In the step S109, a gray scale compensation image out (H, W, b) is calculated by the gradation values (Rᵢₙ, Gᵢₙ, Bᵢₙ, Wᵢₙ) of the converted RGBW pixels and the determined target backlight luminance gain coefficient Blu, and H is the abscissa of the sub-pixel, W is the ordinate, and b is the type that identifies the sub-pixel. For example, when b=1 is a red sub-pixel, when b=2 is a green sub-pixel, when b=3 is a blue sub-pixel, when b=4 is a white sub-pixel.

The step S110, the out (H, W, b) of each RGBW pixel is restored to a gray scale and outputted to the image controller to control the display of the image by operating gamma normalization corresponding to the de-gamma.

From the above, in this application, converting the RGB display to the RGBW avoids problems of pure color darkness from different pixel gain inconsistencies, independently sets saturation gain value in different partitions based on specific screens, and maximizes and enhances penetration rate of W sub-pixel brightness gain effect.

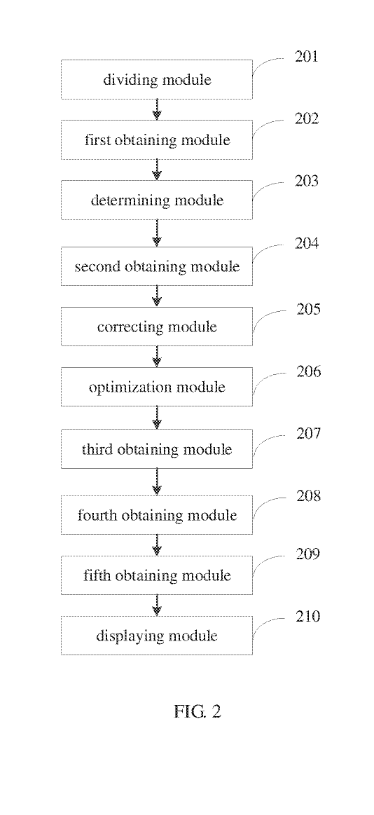

Referring to FIG. 2, FIG. 2 is a structure diagram of a partitioned backlight display device for RGBW displaying according to one exemplary embodiment of the present disclosure, the device comprises: a dividing module 201, a first obtaining module 202, a determining module 203, a second obtaining module 204, a correcting module 205, an optimization module 206, a third obtaining module 207, a fourth obtaining module 208, a fifth obtaining module 209 and a displaying module 210.

The dividing module 201 is used for dividing a red, green, and blue (RGB) image into a plurality of image partitions based on a backlight partition setting information, each image partition comprising a plurality of RGB pixel.

The first obtaining module 202 is used for obtaining a gray scale value of each RGB pixel and converting the gray scale value to a hue, saturation, and value (HSV) space to obtain a saturation of the RGB pixel. The first obtaining module comprises a normalization unit for normalizing the RGB pixels and obtaining a gray scale values of the normalized RGB pixels and a second obtaining unit for obtaining the saturation of the RGB pixel by converting the gray scale value of the RGB pixel to the HSV space.

The determining module 203 is used for determining each of the of RGB pixels being a high-purity color RGB pixel or a non-high-purity color RGB pixel based on the saturation and generating a determining result.

The second obtaining module 204 is used for obtaining a saturation gain corresponding to each of the RGB pixels when each RGB pixel is pre-converted into a RGBW pixel.

The correcting module 205 is used for obtaining a corrected target saturation gain by correcting the saturation gain of each RGB pixel based on the determining result and a visual luminance gain coefficient of each RGB pixel. The correcting module 205 comprises a first obtaining unit for obtaining a visual luminance gain coefficient x of each RGB pixel; a second setting unit for setting the target saturation gain of the RGB pixel to mx, when the RGB pixel is a high-purity color RGB pixel; a third setting unit for setting the target saturation gain to m when the RGB pixel is a high purity color RGB pixel; and m is the saturation gain of the RGB pixel.

The optimization module 206 is used for setting a saturation gain threshold corresponding to each image partition, and performing an optimization process on the target saturation gain for each RGB pixel in the image partition based on the saturation gain threshold. The optimization module 206 comprises a first setting unit for setting a saturation gain threshold corresponding to each image partition; and an optimization unit for adjusting the target saturation gain of the RGB pixel to the corresponding saturation gain threshold when the target saturation gain of the RGB pixel of the image partition is more than the corresponding saturation gain threshold.

The third obtaining module 207 is for obtaining a gray scale value of the RGBW pixel by converting the RGB pixel into an RGBW pixel according to the target saturation gain after the optimization process.

The fourth obtaining module 208 is used for obtaining a target backlight luminance gain coefficient based on the gray scale value of each RGBW pixel in the image partition and the saturation gain threshold corresponding to the image partition.

The fourth obtaining module 208 comprises a setting unit for setting the backlight luminance gain coefficient in the image partition based on the gray scale value of the RGBW pixel in the image partition; and a correcting unit for obtaining the target backlight luminance gain coefficient by correcting the backlight luminance gain coefficient in the image partition based on the saturation gain threshold.

The fifth obtaining module 209 is used for obtaining a gray scale compensation screen of the image partition based on the target backlight luminance gain coefficient of the image partition and the gray scale value of the RGBW pixel in the image partition.

The displaying module 210 is used for displaying based on the gray scale compensation screen of each the image partition.

From the above, in this application, converting the RGB display to the RGBW avoids problems of pure color darkness from different pixel gain inconsistencies, independently sets saturation gain value in different partitions based on specific screens, and maximizes and enhances penetration rate of W sub-pixel brightness gain effect.

As is understood by persons skilled in the art, the foregoing preferred embodiments of the present disclosure are illustrative rather than limiting of the present disclosure. It is intended that they cover various modifications and that similar arrangements be included in the spirit and scope of the present disclosure, the scope of which should be accorded the broadest interpretation so as to encompass all such modifications and similar structures.

What is claimed is:

1. A partitioned backlight display method of a red, green, blue, and white (RGBW) display device, comprising:
dividing a red, green, and blue (RGB) image into a plurality of image partitions based on a backlight partition setting information, each image partition comprising a plurality of RGB pixels;
obtaining a gray scale value of each RGB pixel and converting the gray scale value to a hue, saturation, and value (HSV) space to obtain a saturation of the RGB pixel;
determining each of the of RGB pixels being a high-purity color RGB pixel or a non-high-purity color RGB pixel based on the saturation and generating a determining result;
obtaining a saturation gain corresponding to each of the RGB pixels when each RGB pixel is pre-converted into a RGBW pixel;
obtaining a corrected target saturation gain by correcting the saturation gain of each RGB pixel based on the determining result and a visual luminance gain coefficient of each RGB pixel;
setting a saturation gain threshold corresponding to each image partition, and performing an optimization process on the target saturation gain for each RGB pixel in the image partition based on the saturation gain threshold;
obtaining a gray scale value of the RGBW pixel by converting the RGB pixel into an RGBW pixel according to the target saturation gain after the optimization process;
obtaining a target backlight luminance gain coefficient based on the gray scale value of each RGBW pixel in the image partition and the saturation gain threshold corresponding to the image partition;
obtaining a gray scale compensation screen of the image partition based on the target backlight luminance gain coefficient of the image partition and the gray scale value of the RGBW pixel in the image partition; and
displaying based on the gray scale compensation screen of each the image partition.

2. The partitioned backlight display method of the RGBW display device of claim 1, wherein the step of obtaining a target backlight luminance gain coefficient based on the gray scale value of each RGBW pixel in the image partition and the saturation gain threshold corresponding to the image partition comprises:
setting the backlight luminance gain coefficient in the image partition based on the gray scale value of the RGBW pixel in the image partition; and
obtaining the target backlight luminance gain coefficient by correcting the backlight luminance gain coefficient in the image partition based on the saturation gain threshold.

3. The partitioned backlight display method of the RGBW display device of claim 2, wherein the step of performing an optimization process on the target saturation gain for each RGB pixel in the image partition based on the saturation gain threshold comprises:
adjusting the target saturation gain of the RGB pixel to the corresponding saturation gain threshold when the target saturation gain of the RGB pixel of the image partition is more than the corresponding saturation gain threshold.

4. The partitioned backlight display method of the RGBW display device of claim 1, wherein the step of obtaining a corrected target saturation gain by correcting the saturation gain of each RGB pixel based on the determining result and a visual luminance gain coefficient of each RGB pixel comprises:
obtaining a visual luminance gain coefficient x of each RGB pixel;
the target saturation gain of the RGB pixel has n=mx, when the RGB pixel is a high-purity color RGB pixel;
the target saturation gain n=m, when the RGB pixel is a high purity color RGB pixel; and
wherein, m is the saturation gain of the RGB pixel.

5. The partitioned backlight display method of the RGBW display device of claim 1, the step of obtaining a gray scale value of each RGB pixel and converting the gray scale value to a HSV space to obtain a saturation of the RGB pixel comprises:
normalizing the RGB pixels and obtaining a gray scale values of the normalized RGB pixels; and
obtaining the saturation of the RGB pixel by converting the gray scale value of the RGB pixel to the HSV space.

6. A partitioned backlight display device for RGBW displaying, comprising:
a dividing module for dividing a red, green, and blue (RGB) image into a plurality of image partitions based on a backlight partition setting information, each image partition comprising a plurality of RGB pixels;
a first obtaining module for obtaining a gray scale value of each RGB pixel and converting the gray scale value to a hue, saturation, and value (HSV) space to obtain a saturation of the RGB pixel;
a determining module for determining each of the of RGB pixels being a high-purity color RGB pixel or a non-high-purity color RGB pixel based on the saturation and generating a determining result;
a second obtaining module for obtaining a saturation gain corresponding to each of the RGB pixels when each RGB pixel is pre-converted into a RGBW pixel;
a correcting module for obtaining a corrected target saturation gain by correcting the saturation gain of each RGB pixel based on the determining result and a visual luminance gain coefficient of each RGB pixel;
an optimization module for setting a saturation gain threshold corresponding to each image partition, and performing an optimization process on the target saturation gain for each RGB pixel in the image partition based on the saturation gain threshold;
a third obtaining module for obtaining a gray scale value of the RGBW pixel by converting the RGB pixel into an RGBW pixel according to the target saturation gain after the optimization process;
a fourth obtaining module for obtaining a target backlight luminance gain coefficient based on the gray scale value of each RGBW pixel in the image partition and the saturation gain threshold corresponding to the image partition;
a fifth obtaining module for obtaining a gray scale compensation screen of the image partition based on the target backlight luminance gain coefficient of the image partition and the gray scale value of the RGBW pixel in the image partition; and
a displaying module for displaying based on the gray scale compensation screen of each the image partition.

7. The partitioned backlight display device for RGBW displaying of claim 6, wherein the fourth obtaining module comprises:
a setting unit for setting the backlight luminance gain coefficient in the image partition based on the gray scale value of the RGBW pixel in the image partition; and
a correcting unit for obtaining the target backlight luminance gain coefficient by correcting the backlight luminance gain coefficient in the image partition based on the saturation gain threshold.

8. The partitioned backlight display device for RGBW displaying of claim 7, wherein the optimization module comprises:
a first setting unit for setting a saturation gain threshold corresponding to each image partition; and
an optimization unit for adjusting the target saturation gain of the RGB pixel to the corresponding saturation gain threshold when the target saturation gain of the RGB pixel of the image partition is more than the corresponding saturation gain threshold.

9. The partitioned backlight display device for RGBW displaying of claim 6, wherein the correcting module comprises:
a first obtaining unit for obtaining a visual luminance gain coefficient x of each RGB pixel;
a second setting unit for setting the target saturation gain of the RGB pixel to mx, when the RGB pixel is a high-purity color RGB pixel;
a third setting unit for setting the target saturation gain to m when the RGB pixel is a high purity color RGB pixel; and
wherein, m is the saturation gain of the RGB pixel.

10. The partitioned backlight display device for RGBW displaying of claim 6, wherein the first obtaining module comprises:
a normalization unit for normalizing the RGB pixels and obtaining a gray scale values of the normalized RGB pixels; and
a second obtaining unit for obtaining the saturation of the RGB pixel by converting the gray scale value of the RGB pixel to the HSV space.

11. A partitioned backlight display device for RGBW displaying comprising:
a dividing module for dividing a red, green, and blue (RGB) image into a plurality of image partitions based on a backlight partition setting information, each image partition comprising a plurality of RGB pixels;
a first obtaining module for obtaining a gray scale value of each RGB pixel and converting the gray scale value to a hue, saturation, and value (HSV) space to obtain a saturation of the RGB pixel;
a determining module for determining each of the of RGB pixels being a high-purity color RGB pixel or a non-high-purity color RGB pixel based on the saturation and generating a determining result;
a second obtaining module for obtaining a saturation gain corresponding to each of the RGB pixels when each RGB pixel is pre-converted into a RGBW pixel;
a correcting module for obtaining a corrected target saturation gain by correcting the saturation gain of each RGB pixel based on the determining result and a visual luminance gain coefficient of each RGB pixel;
an optimization module for setting a saturation gain threshold corresponding to each image partition, and performing an optimization process on the target saturation gain for each RGB pixel in the image partition based on the saturation gain threshold;
a third obtaining module for obtaining a gray scale value of the RGBW pixel by converting the RGB pixel into an RGBW pixel according to the target saturation gain after the optimization process;
a fourth obtaining module for obtaining a target backlight luminance gain coefficient based on the gray scale value of each RGBW pixel in the image partition and the saturation gain threshold corresponding to the image partition;
a fifth obtaining module for obtaining a gray scale compensation screen of the image partition based on the target backlight luminance gain coefficient of the image partition and the gray scale value of the RGBW pixel in the image partition; and
a displaying module for displaying based on the gray scale compensation screen of each the image partition;
wherein the fourth obtaining module comprising:
a setting unit for setting the backlight luminance gain coefficient in the image partition based on the gray scale value of the RGBW pixel in the image partition; and
a correcting unit for obtaining the target backlight luminance gain coefficient by correcting the backlight luminance gain coefficient in the image partition based on the saturation gain threshold;
wherein the optimization module comprising:
a first setting unit for setting a saturation gain threshold corresponding to each image partition; and
an optimization unit for adjusting the target saturation gain of the RGB pixel to the corresponding saturation gain threshold when the target saturation gain of the RGB pixel of the image partition is more than the corresponding saturation gain threshold;
wherein the correcting module comprising:
a first obtaining unit for obtaining a visual luminance gain coefficient x of each RGB pixel;
a second setting unit for setting the target saturation gain of the RGB pixel to mx, when the RGB pixel is a high-purity color RGB pixel;
a third setting unit for setting the target saturation gain to m when the RGB pixel is a high purity color RGB pixel; and
wherein, m is the saturation gain of the RGB pixel; and
wherein the first obtaining module comprising:
a normalization unit for normalizing the RGB pixels and obtaining a gray scale values of the normalized RGB pixels; and
a second obtaining unit for obtaining the saturation of the RGB pixel by converting the gray scale value of the RGB pixel to the HSV space.
